(19) United States
(12) Patent Application Publication
(10) Pub. No.: US 2002/0099668 A1
(43) Pub. Date: Jul. 25, 2002

(54) Efficient revocation of registration authorities

(75) Inventor: Radia J. Perlman, Acton, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Sun Microsystems, Inc.

(21) Appl. No.: 09/767,128

(22) Filed: Jan. 22, 2001

(51) Int. Cl. G06F 17/60

(52) U.S. Cl. 705/76

(57) ABSTRACT

A method and system for revoking a certificate issued by a certification authority (CA). An identifier associated with a registration authority (RA) that requested issuance of a certificate on behalf of a principal is included within the certificate that is issued by the CA. Additionally, a time stamp indicating when the respective RA requested the certificate may be included in the certificate. In response to a request from a principal to a server for access to a resource, the server verifies the request using a decryption key contained in the certificate. Additionally, in a first embodiment a determination is made whether the RA identifier contained within the certificate is present on a certificate revocation list (CRL) maintained by a revocation server. If the RA identifier is present on the CRL, an indication is provided to the server that the certificate has been revoked and access to the requested resource may be denied. In a second embodiment, a determination is made whether the RA identifier is contained on the CRL and whether the time stamp contained within the certificate corresponds to a time period indicated in the CRL during which the respective RA was deemed untrustworthy. If the RA identifier in the certificate corresponds to an RA identifier on the CRL and the time stamp in the certificate is within a period in which the respective RA was deemed untrustworthy, an indication is provided to the respective server that the certificate has been revoked and access to the requested resource may be denied.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates to security mechanisms within computer networks and more specifically, to a method and system for efficiently revoking a certificate issued by a certification authority upon a request from a a registration authority.

The use of certification authorities and registration authorities within computer networks is well known. A certification authority issues certificates that may be relied upon by other parties that trust the respective certification authority. For example, a certification authority may issue an identity certificate that includes the identity of a principal and a public key associated with the principal. The certification authority issuing the certificate typically authenticates the certificate. Alternatively, a certificate may comprise a group membership certificate that identifies members of a group, the identity of subgroups that identify members of the group, or non-members of the group.

In a number of circumstances a hierarchical structure is established in which information used by a certification authority to grant a certificate is obtained from one or more registration authorities (RAs). Multiple RAs may be provided in a system for the convenience of the principals. For example, it may be desirable to have an RA at each corporate office but only have certificates issued by a single CA. In this circumstance information necessary for the CA to issue a certificate must be obtained from the respective RA.

The use of RAs in association with CAs for the generation and issuance of certificates is well known in the art. Such systems often employ the Public Key Infrastructure (PKI) and rely on the use of public/private key pairs for purposes of authentication. Only the certification authority may know the RA public keys. A principal can request a certificate from one of a plurality of RAs that is accessible by the principal. The PA, in response to the request from the principal, forwards a request to the CA to issue a certificate for the principal. The request may be digitally signed using the private key of the respective RA. Upon verification by the CA that the request is authentic, the CA issues the certificate. One known Certificate Request Message Format (CRMF) is described in the Internet X.509 Certificate Request Message Format specification dated March 1999 and described in Request for Comments (RFC) 2511.

Subsequent to the issuance of a certificate by a CA based upon information provided by an RA, however, it may be determined that the RA has become untrustworthy.

While it is straightforward to prevent the CA from issuing further certificates based upon information provided by the untrustworthy RA, it is not easy to revoke previously issued certificates based upon information provided by the untrustworthy RA. The CA may revoke the certificates issued by the untrustworthy RA. The certificates, however, must be revoked individually and each certificate must be listed in and tested against a potentially large certificate revocation list (CRL) to ascertain whether the specific certificate is contained on the respective list. This can be a time consuming process that adds latency to the determination of whether a particular certificate has been revoked.

Various techniques have been proposed for managing the certificate revocation process. Two such techniques are described in U.S. Pat. Nos. 5,261,002 and 5,687,235. Such techniques, however, do not address the problem of how to efficiently revoke certificates upon recognition that a particular RA has been untrustworthy.

It would therefore be desirable to have an efficient mechanism for revoking certificates issued by a CA at the request of an RA that has been determined to be untrustworthy.

### BRIEF SUMMARY OF THE INVENTION

Consistent with the present invention, a method and system for efficiently revoking certificates that were generated by a certification authority (CA) in response to a request from a registration authority is disclosed. Upon receipt of sufficiently trustworthy information from or on behalf of a principal that requests issuance of a certificate for the respective principal, the registration authority generates a certificate request message (CRM) on behalf of the principal and forwards the. CRM to a certification authority. The CRM typically includes the identity of the principal and the identity of the RA and may be authenticated by the RA that generated the request. The CA, upon receipt of the CRM from the RA, in a preferred embodiment, generates a certificate that includes the identity of the principal. The principal may comprise an individual, a client, a server, a software process, identifiable hardware or a system component, or a group. The certificate also includes an RA identifier associated with the RA that forwarded the respective CRM. Optionally, the certificate may include the time at which the CRM was forwarded by the respective CRM to the CA.

In response to a determination that the RA that requested issuance of the respective certificate has become untrustworthy, the CA may generate an entry within a Certificate Revocation List (CRL) in the form of an RA identifier that identifies the untrustworthy RA.

In response to a request for service or access to a resource received at a server from a principal, a determination is made whether the principal is authorized to obtain the requested service. During the authentication process, the server accesses a certificate associated with the principal that includes a public key key associated with the principal. The public key may be used by the server to verify the principal's request. Additionally, a determination is made whether the RA identifier contained within the respective certificate matches an RA identifier on the CRL prior to granting access to the requested service or resource. In the event the RA identifier within the certificate matches the RA identifier within the CRL, an indication is provided to the server that the certificate has been revoked. In response to this indication, the server may deny service to the requesting principal. Alternatively, if the determination reveals that the RA identifier contained within the respective certificate is not contained on the CRL, the server may grant access to the requested service or resource or perform additional validations pertaining to the request prior to granting such access.

In the event that the RA has become untrustworthy, in addition to the RA identifier that is added to the CRL, a date or dates may be included in the CRL in association with the RA identifier. The date(s) specify a period or period(s) for which certificates issued by a CA at the request of the respective RA are deemed to be untrustworthy. More specifically, certificates issued within such periods are deemed to be revoked. For example, a single date may be associated with an RA identifier in the CRL. All certificates requested by the respective RA after the date specified within the CRL may be considered to be revoked. Additionally, multiple dates defining beginning and ending times of a period or periods may be employed to identify certificates that have been issued by the CA in response to CRMs from an RA at times when the RA is deemed to have been untrustworthy and thus revoked.

Other features, aspects and advantages of the presently disclosed method and system will be apparent from the Detailed Description of the Invention that follows.

### BRIEF DESCRIPTION OF THE SEVERAL VIEWS OF THE DRAWING

The invention will be more fully understood by reference to the Detailed Description of the Invention in conjunction with the Drawings, of which:

FIG. 1 is a block diagram illustrating a system operative in a manner consistent with the present invention;

FIG. 2 is a block diagram of an exemplary computer system that may be employed to perform the functions of the client, the servers, registration authorities and certification authorities depicted in FIG. 1;

FIG. 3 is a flow diagram illustrating an exemplary method of operation of the system depicted in FIG. 1 for generating a certificate in a manner consistent with the present invention;

FIG. 4 is a flow diagram illustrating an exemplary method of operation of the system depicted in FIG. 1 for revoking a certificate;

FIG. 5 is a diagram of an exemplary certificate request message forwarded from a registration authority to a certification authority to request issuance of a certificate for a principal; and

FIG. 6 is a diagram illustrating a certificate that includes a registration authority identifier and a time stamp that identifies the time associated with the certificate request message.

### DETAILED DESCRIPTION OF THE INVENTION

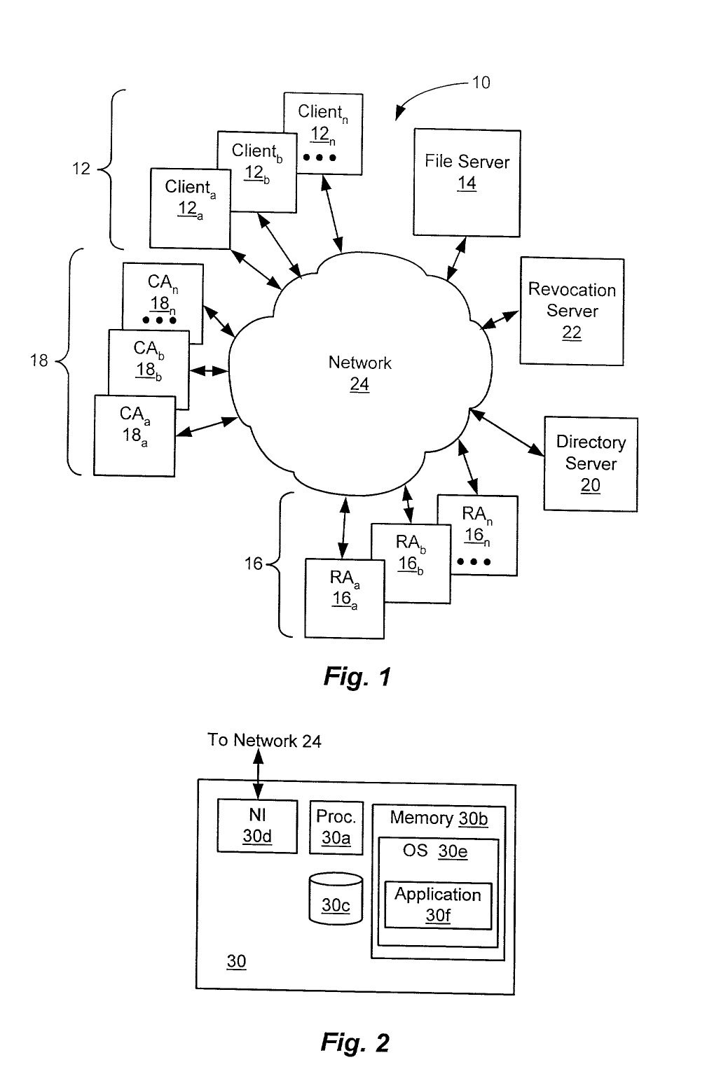

A system 10 for efficiently revoking certificates issued by a certification authority upon a request from a registration authority is depicted in FIG. 1. The system 10 includes a plurality of clients 12 identified as clients 12ₐ through 12ₙ, at least one service such as provided by a file server 14, a plurality of registration authorities (RAs)16 identified as RAs 16ₐ through 16ᵣ and at least one certification authority (CA) 18. A plurality of certification authorities designated 18ₐ through 18ₙ are illustrated. Additionally, the system 10 includes a directory server (DS) 20 that is operative to provide access to certificates issued by one or more of the CAs 18 and a revocation server (RS) 22 that maintains one or more certificate revocation lists (CRLs). The clients 12, the file server 14, the RAs 16, the CAs 18, the directory server 20 and the revocation server 22 are communicably coupled via a network 24 to allow the communication of information and/or messages between the respective devices. The network 24 may comprise a local area network, a wide area network, a global computer network such as the Internet, or any other network for communicatively coupling the respective devices.

The clients 12, the file server 14, the RAs 16, the CAs 18, the directory server 20 and the revocation server 22 each typically comprise a computer system 30 such as depicted generally in FIG. 2. The computer system 30 may be in the form of a personal computer or workstation, a personal digital assistant (PDA), an intelligent networked appliance, a controller or any other device capable of performing the functions attributable to the respective devices as described herein.

More specifically, referring to FIG. 2, the computer system 30 typically includes a processor 30a that is operative to execute programmed instructions out of an instruction memory 30b. The instructions executed in performing the functions herein described may comprise instructions stored within program code considered part of an operating systems 30e, instructions stored within program code considered part of an application 30f or instructions stored within program code allocated between the operating system 30e and the application 30f. The memory 30b may comprise random access memory or a combination of random access memory and read only memory. Each device within the system 10 includes a network interface 30d for coupling the respective device to the network 24. The devices within the system 10 may optionally include secondary storage 30c.

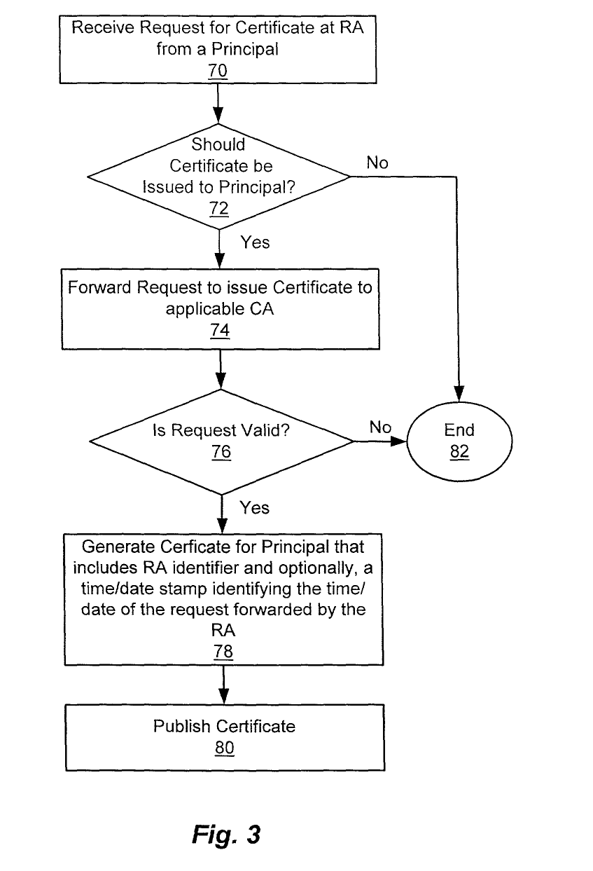

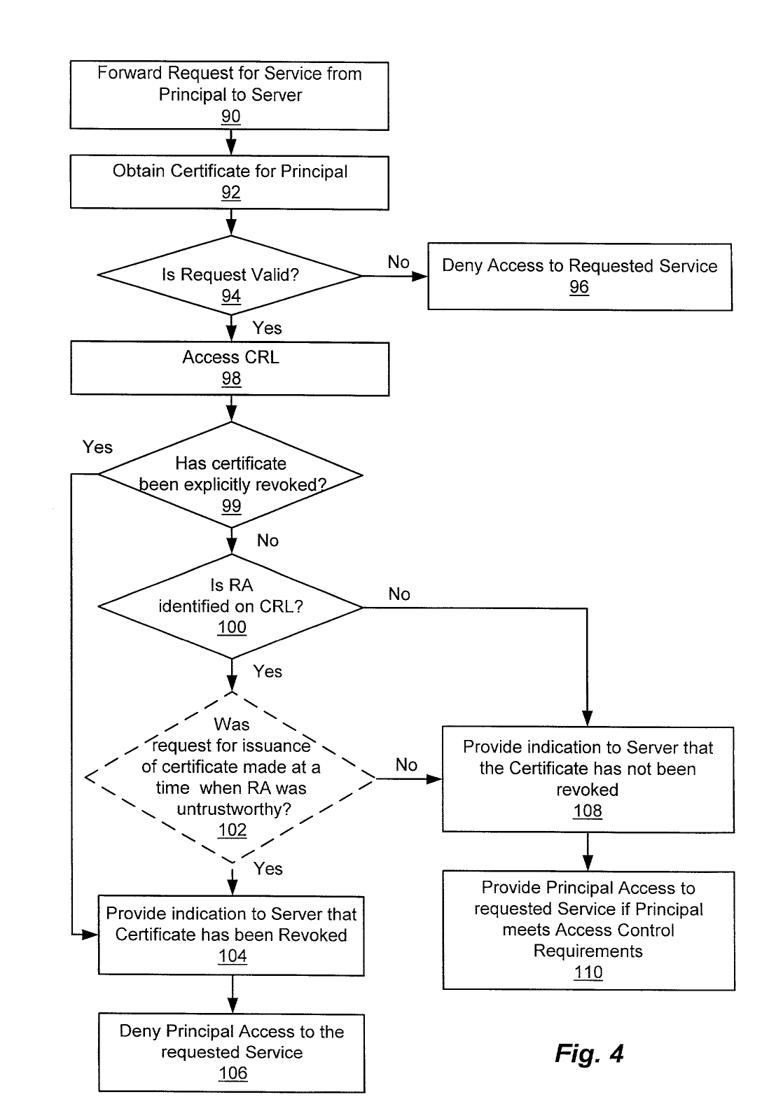

The operation of the system 10 may be considered in two phases. The first phase is illustrated in the flow diagram of FIG. 3 and involves the generation of a certificate on behalf of a principal and the second phase, illustrated in the flow diagram of FIG. 4, involves the use of the certificate in a determination of whether access to a resource or service accessible via the network 24 should be made available to the requesting principal. As described above, for purposes of the present discussion, the term “principal” is intended to refer to nodes within the computer network such as a client or a server, a software process running on a network node, a user or any other component within the network that is capable of requesting access to a service or resource available via the network 24.

More specifically, referring to FIG. 3, an RA 16 receives a request for issuance of a certificate on behalf of a principal as depicted is step 70. For purposes of illustration, it is assumed that the principal comprises clientₐ 12ₐ and the RA 16 comprises RAₐ 16ₐ. The principal may provide the request directly to RAₐ 16ₐ, or alternatively, the request may be provided to RAₐ 16ₐ by a system administrator (not shown). In response to the request to RAₐ 16ₐ for issuance of a certificate for the principal, as illustrated in step 72, RAₐ 16ₐ may make a determination whether a certificate should be issued for the principal, namely client 12ₐ. The determination may comprise an analysis of credentials accompanying the request, verifying the authenticity of the request, or any other suitable basis for determining whether the certificate should be issued for the principal. In the event it is determined in inquiry step 72 that no certificate should be issued, no certificate is generated and the process of certificate generation terminates as illustrated in step 82. In the event it is determined in inquiry step 72 that a certificate should be issued for the principal, a certificate request message (CRM) is forwarded from RAₐ 16ₐ to a certification authority 18. For purposes of the present example, it is assumed that the CRM is forwarded from registration authority RA 16ₐ to CAₐ 18_{a.}

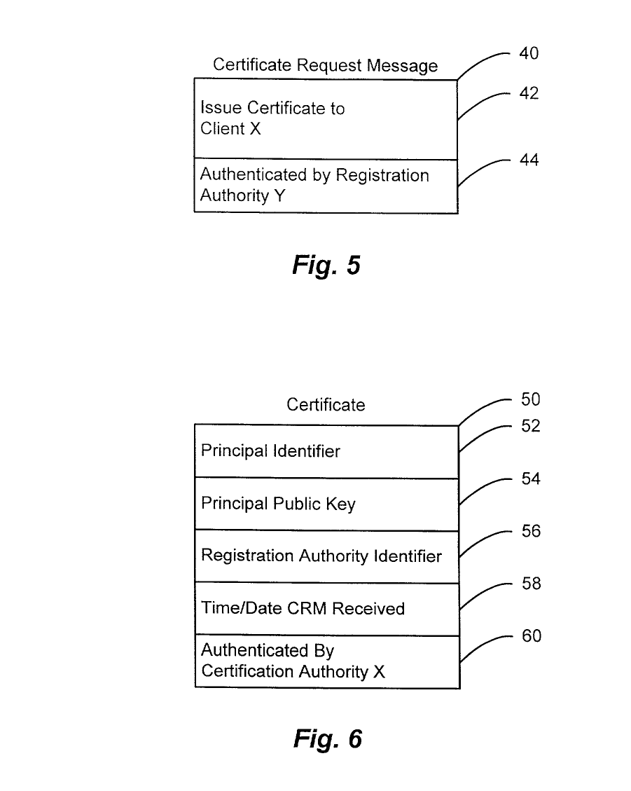

An illustrative CRM 40 is depicted in FIG. 5. Referring to FIG. 5, the CRM 40 typically includes at least a certificate request portion 42 and an authentication portion 44. The certificate request portion 42 comprises a request from the respective RA 16 to the respective CA 18 that a certificate be issued for the principal identified in the certificate request portion 42 e.g. client 12ₐ in the present example. When the public key infrastructure (PKI) is being employed, the authentication portion 44 may comprise a digital signature in which the certificate request message 40 is signed by the RA 16 using the RA's respective private key.

Referring again to FIG. 3, upon receipt of the CRM 40 at CAₐ 18, a determination is made by CAₐ 18ₐ whether the request received from RAₐ 16ₐ is a valid request as depicted in decision step 76. More specifically, if CAₐ 18ₐ determines that the request is not a valid request, CAₐ 18ₐ does not generate a certificate for the respective principal and certificate generation terminates as depicted in step 82. In the event that CAₐ 18ₐ determines that the CRM comprises a valid request, certificate generation continues, as depicted in step 78. The process of verifying the CRM may comprise the step of verifying the authenticity of the CRM 40 by using the public key of RAₐ 16ₐ to check a digital signature included in the CRM 40. Alternatively, any other suitable technique for authenticating the CRM 40 may be employed. Additionally, the CAₐ 18ₐ may optionally verify other credentials pertaining to the CRM or the principal or perform other tests prior to generation of a certificate for the principal.

Upon determining that the CRM 40 comprises a valid request for issuance of a certificate, CAₐ 18ₐ generates the certificate as depicted in step 78. An exemplary certificate issued by a CA 18, such as CAₐ 18ₐ, in response to a valid CRM 40 is illustrated in FIG. 6.

Referring to FIG. 6, the certificate 50 includes a principal identifier 52 associated with the respective principal, a principal public key 54 associated with the principal identifier 54, and an RA identifier 56 that identifies the respective RA 16 that forwarded the CRM 40 to the respective CA 18 requesting issuance of the certificate 50. Additionally, the certificate 50 may optionally include a time stamp 58 that indicates the time when the CRM 40 was received by the CA 18. The certificate 50 further includes an authentication portion 60 that may comprise the digital signature of the CA 18 issuing the certificate 50 or any other suitable form of authentication. By way of illustration, it is assumed that the certificate 50 includes a principal identifier for clientₐ 12ₐ, the public key associated with a private key owned by clientₐ 12ₐ, an RA identifier for RAₐ 16ₐ and a time stamp that specifies the time when the respective CRM 40 was received by CAₐ 18ₐ from RAₐ 16ₐ. In the illustrative example, the certificate 50 is digitally signed by CAₐ 18ₐ using the private key owned by that CA.

The certificate 50 generated in the above-described manner is published by CAₐ 18ₐ as illustrated in step 80. Publication may involve transmittal of the certificate 50 to a directory server 20 (FIG. 1) that maintains certificates 50 generated by CAₐ 18ₐ. Alternatively, the certificates may be delivered to the respective principal. Any other suitable technique known in the art for publishing or distributing the certificates 50 may also be employed.

The use of the certificate 50 during system 10 operation is described below with respect to FIGS. 1, 4 and 6.

When a principal desires to obtain access to a service or resource accessible via the network 24, the principal generates a request for the identified service or resource and transmits the request over the network 24 to the applicable server as depicted in step 90. For purposes of illustration, it is assumed that clientₐ 12ₐ desires to access a file maintained on the file server 14 (FIG. 1). While the resource is depicted to be a file stored on a file server 14, it should be appreciated that clientₐ 12ₐ or any other principal may be attempting to obtain access to any service or resource accessible via the network 24. Upon receipt of the request at the file server 14, the file server 14 obtains the certificate 50 for the principal, e.g. clientₐ 12ₐ as depicted in step 92. The certificate 50 may be stored locally, may be obtained from the principal, or may be obtained from the directory server 20. The file server 14 determines whether the request received from the respective principal comprises a valid request as depicted in inquiry step 94. For example, the file server 14 may obtain the certificate 50 for clientₐ 12ₐ from the directory server 20 and utilize a public key associated with clientₐ 12ₐ that is contained within the respective certificate to verify a digital signature in the request from clientₐ 12ₐ. In the event the file server 14 determines that the request from clientₐ 12ₐ is not a valid request, the file server 14 denies access to the requested file as illustrated in step 96. In the event the file server 14 determines that the request is a valid request, the file server 14 determines whether the certificate for the respective principal has been revoked. In this regard, the file server 14 accesses a copy of the CRL as depicted in step 98. More specifically, the file server 14 retrieves a recent copy of the CRL if it does not possess a recent copy via any suitable CRL distribution or publishing technique known in the art. The distribution of CRLs identifying untrustworthy RAs throughout the network has several advantages. First, since many certificates may be issued at the request of a single RA, all of the certificates that are deemed untrustworthy need not be separately identified in the CRL. Rather, such certificates may be identified via a single entry in the CRL. Accordingly, processing resources needed to update the CRL are reduced. Additionally, the CRL is smaller in size, less bandwidth is required to distribute the CRL to various services throughout the network and the CRL occupies less storage space once distributed to each of the various services.

A determination is made, as depicted in step 99, whether the certificate has been explicitly revoked. In the event the certificate has been explicitly revoked, control passes to step 104. If the certificate has not been explicitly revoked, control passes to step 100.

In the event it is determined that either the certificate has been explicitly revoked, as determined in step 99, or that the certificate has been issued by an RA that has been deemed untrustworthy, as indicated per steps 100 and 102, access to the requested service may be denied as illustrated in step 104.

In an alternative embodiment, the file server 14 may forward the certificate to the revocation server 22 and the revocation server may analyze a CRL maintained at the revocation server 22 to determine whether the certificate 50 has been explicitly revoked as depicted in step 99 or if the RA identified in the certificate matches an RA identifier on the CRL as depicted in step 100. In such event, the revocation server 22 provides an indication to the file server 14 indicating whether the certificate was explicitly revoked or whether the certificate contained an identifier of an RA that has been deemed untrustworthy.

As indicated above, the CRL may include RA identifiers of RAs 16 that have been deemed to be untrustworthy. An entry on the CRL identifying an untrustworthy RA may optionally include a time threshold that specifies when the respective RA became untrustworthy. The entry may be readily employed to revoke certificates issued by a CA 18 in response to a request by the respective RA 16 as described below.

Assume in a first example, that RAₐ 16ₐ has become untrustworthy, and that it is desired to revoke all certificates that were issued by RAₐ 16ₐ. An entry in the CRL identifying an RA identifier for RAₐ 16ₐ would be inserted in the CRL. In response to an inquiry from the file server 14 a determination is made whether the RA identifier contained within the respective certificate is contained within the CRL as illustrated in step 100. In response to a determination that the RA identifier contained within the certificate 50 is not identified on the CRL, an indication is provided that the respective certificate 50 has not been revoked as illustrated in step 108. In response to this indication, the principal, e.g. clientₐ 12ₐ is provided access to the requested file. In the event the RA identifier contained within the respective certificate is contained in the CRL (assuming for the present example no time stamp is employed) control passes to step 104. As indicated in step 104, an indication is provided that the certificate has been revoked and, as indicated in step 106, access to the requested resource (file) is denied.

In a further example, it is assumed that it has been-determined that at timeₓ, RAₐ 16ₐ has become untrustworthy and accordingly, it is desired to revoke all certificates issued by RAₐ 16ₐ after timeₓ. In such event, an entry may be made in the CRL that identifies the respective RA that became untrustworthy along with an indication of the time when the respective RA became untrustworthy. For example, assuming RAₐ 16ₐ became untrustworthy as of timeₓ, an entry on the CRL may be may be provided as follows:

RAₐ timeₓ

Thus, returning to FIG. 4, the CRL is analyzed to determine whether the RA identifier contained within the certificate 50 corresponds to an entry in the CRL as depicted in step 100. In the event the RA identifier contained within the respective certificate 50 is listed on the CRL, control passes to inquiry step 102. As indicated in inquiry step 102, a determination is made whether the time stamp within the certificate 50 that indicates when RAₐ 16ₐ requested issuance of the respective certificate is after timeₓ contained within the respective entry on the CRL. In the event the certificate 50 was requested by RAₐ 16ₐ after timeₓ when the respective RA 16 was determined to have become untrustworthy, an indication is provided to the file server 14 that the certificate 50 is untrustworthy or has been revoked as illustrated in step 104, and access to the requested resource or service is denied as depicted in step 106. In the event the time stamp contained within the respective certificate 50 was generated before timeₓ, an indication is provided to the file server 14 that the certificate 50 has not been revoked, as indicated in step 108, and access to the requested resource is provided if the principal satisfies other applicable access control requirements as illustrated in step 110.

In a further example, the CRL may contain a number of time periods in which the respective RA has been determined to be untrustworthy, and an indication may be provided to the file server 14 that a certificate 50 has been revoked if the respective certificate 50 was requested by the untrustworthy RA 16 during any period in which that RA has been determined to be untrustworthy. For example, an entry in the CRL may be provided as follows:

RAₐ timeₛ₁, timeₑ₁, timesₛ₂, timeₑ₂, timeₛ₃

where timeₛ₁ indicates the beginning of the first period in which RAₐ 16ₐ was determined to have become untrustworthy, timeₑ₁ indicates the end of the first period in which RAₐ 16ₐ was determined to have become untrustworthy, timeₛ₂ indicates the beginning of the second period in which RAₐ 16ₐ was determined to have become untrustworthy, timeₑ₂ indicates the end of the second period in which RAₐ 16ₐ was determined to have become untrustworthy, and timeₛ₃ indicates the beginning of the third period in which RAₐ 16ₐ was determined to have become untrustworthy. Since no end time is provided for the third period, any certificates 50 requested by RAₐ 16ₐ after timeₛ₃ are considered untrustworthy. More specifically, in the event a single starting time stamp is provided, the end of the period in which the respective RA 16 is considered to be untrustworthy is assumed to be the present time.

In the foregoing manner, an efficient mechanism for revoking certificates issued by a CA in response to a request from an RA is provided. The presently described technique permits CRLs to be generated more quickly and produces smaller CRLs. The smaller CRLs utilize less bandwidth during distribution and require less memory to store. Such memory savings are magnified by the number of services that store a copy of the CRL. Accordingly, overall performance of the system is improved.

Those skilled in the art should readily appreciate that the programs defining the functions performed by the respective devices described herein can be communicated to the respective devices in many forms including, but not limited to: (a) information permanently stored on non-writable storage media (e.g., read-only memory devices within a computer such as ROM or CD-ROM disks readable by a computer I/O attachment; (b) information alterably stored on writable storage media (e.g., floppy disks, tapes, read/write optical media and hard drives); or (c) information conveyed to a computer through a communication media, for example, using baseband signaling or broadband signaling techniques, such as over computer or telephone networks via a modem. In addition, while in the present embodiment the functions are illustrated as being software-driven and executable out of a memory by a processor, the presently described functions may alternatively be embodied in part or in whole using hardware components such as Application Specific Integrated Circuits (ASICs), programmable logic arrays, state machines, controllers or other hardware components or devices, or a combination of hardware components and software.

While the above-described examples illustrate a technique for accessing a file on a file server and the use of a certificate including an RA identifier in that process, it should be appreciated that the presently disclosed methods and systems may be used for determining whether access should be provided to any suitable service or resource accessible over a network such as a web page, a secure area, data within a database or privileges within a computer network.

Additionally, it should be appreciated that the authentication techniques described hereinabove may involve digital signatures based upon public/private key pairs as employed within the public key infrastructure (PKI), other asymmetric key pairs or symmetric keys. Additionally, authentication may be performed using a keyed hash, any suitable cryptographic hash incorporated in an encrypted message or any other suitable authentication technique known in the art.

Moreover, while the term certificate, as used herein, is intended to include traditional certificates, such as identity or group certificates that include an identifier of a party or group and an associated public key, the term certificate, is also intended to encompass any document or data structure that is issued at the request of a first party by a second party and that contains an identifier indicative of the identification of the first party, whether or not the certificate is authenticated by the second party. By way of example and not limitation, a certificate may include an identifier for a party and the name of group a group in which the party is a member. Additionally, a certificate may include the name of a party and a dollar amount that the party is authorized to sign for.

Finally, it will be appreciated by those of ordinary skill in the art that modifications to and variations of the above-described methods and system for efficiently revoking revoking certificates generated at the request of a first node by a second node may be made without departing from the inventive concepts described herein. Accordingly, the invention should not be viewed as limited except as by the scope and spirit of the appended claims.

What is claimed is:

1. A method for certificate generation comprising the steps of:
forwarding a request from a first node to a second node to generate a certificate, wherein said request includes a first identifier that identifies the first node; and
in response to receipt of the request at the second node, generating a certificate that includes said first identifier.

2. The method of claim 1 wherein said request further includes a second identifier that identifies a principal.

3. The method of claim 2 wherein said certificate further includes a public key associated with said principal, and said second identifier.

4. The method of claim 1 further including the step of authenticating said certificate by said second node.

5. The method of claim 4 wherein said step of authenticating said certificate comprises the step of generating a certificate digitally signed by said second node.

6. The method of claim 5 wherein said step of generating said certificate signed by said second node comprises the step of generating a certificate digitally signed by said second node using a private key of a public private key pair associated with said second node.

7. The method of claim 1 wherein said certificate further includes a time stamp that identifies a time associated with the request.

8. The method of claim 1 further including the step of authenticating said request by said first node.

9. The method of claim 8 wherein said step of authenticating said request by said first node comprises the step of digitally signing said request.

10. The method of claim 9 wherein said step of digitally signing said request comprises the step of digitally signing said request using a private key of a public/private key pair associated with said first node.

11. The method of claim 1 wherein said certificate further includes a time stamp that is associated with a time and date when said request was received by said second node.

12. A method for determining whether access to a resource should be provided to a principal in response to a request for access to the resource by the principal comprising the steps of:
receiving said request for access to said resource from said principal at a server;
verifying the authenticity of said request using a key contained within a certificate associated with said principal;
determining whether a registration authority identifier within said certificate corresponds to a registration identifier contained on a certificate revocation list, wherein said registration authority identifier is associated with a registration authority that requested a certification authority to generate said certificate; and
providing an indication to said server that said certificate has been revoked and denying access of said principal to said resource in response to a determination that said registration authority identifier within said certificate corresponds to a registration authority identifier on said certificate revocation list.

13. The method of claim 12 wherein said determining step further comprises the step of determining whether a time stamp contained within said certificate that specifies a time of receipt of a request from said registration authority to the certification authority to generate the certificate corresponds to a period identified on said certificate revocation list during which the respective registration authority is indicated to be untrustworthy; and
said providing step comprises the step of providing said indication to said server that said certificate has been revoked and denying access of said principal to said resource in response to a determination that said registration authority identifier within said certificate corresponds to said registration authority identifier on said certificate revocation list and said time stamp within said certificate corresponds to a time within said period identified on said certificate revocation list during which said registration authority was indicated to be untrustworthy.

14. The method of claim 13 wherein said period has a beginning point and an assumed ending point, said beginning point being specified by a time value contained within said certificate revocation list and the assumed ending point corresponds to a present time value.

15. The method of claim 13 wherein said period has a beginning point and an ending point, said beginning point being specified by a first time value and the ending point corresponds to a second time value.

16. The method of claim 12 wherein said verifying and determining steps are performed by said server.

17. A certification authority comprising:
a memory containing a computer program for generating said certificate; and
a processor operative to execute said computer program, said computer program containing program code for:
receiving a request from a registration authority to issue said certificate; and
in response to receipt of said request, generating said certificate that includes at least a registration authority identifier associated with said registration authority.

18. The certification authority of claim 17 wherein said request to issue said certificate is an authenticated request and said computer program further includes program code for verifying said authenticated request.

19. The certification authority of claim 17 wherein said certificate generated by said computer program further includes a principal identifier associated with a principal and a key associated with said principal.

20. The certification authority of claim 17 wherein said computer program further includes program code for storing within said certificate a time stamp associated with a time when said certification authority received said request from said registration authority.

21. A system for determining whether access to a resource should be provided to a principal in response to a request for access to the resource by the principal comprising:
a first server operative to receive a request for access to said resource from said principal, said first server being operative to verify the authenticity of said request using a key contained within a certificate associated with said principal, wherein said certificate includes at least a registration authority identifier associated with a registration authority that issued a request to a certification authority to issue said certificate;
a second server containing a certificate revocation list, wherein said certificate revocation list includes said registration authority identifier in the event the associated registration authority has been determined to be untrustworthy, said second server being operative in response to a certificate revocation inquiry request to ascertain whether said certificate revocation list contains a registration authority identifier that corresponds to said registration authority identifier within said certificate; and
said second server being further operative to provide an indication to said first server that said certificate has been revoked in the event said certificate revocation list contains said registration authority identifier that corresponds to said registration authority identifier within said certificate.

22. The system of claim 21 wherein said first and second server comprise a single server.

23. The system of claim 21 wherein said first server is further operative in response to receipt of said indication that said certificate has been revoked to deny said principal access to said requested resource.

24. The system of claim 21 wherein said certificate further includes a time stamp associated with a time when said certification authority received from said registration authority said request to issue said certificate on behalf of said principal; and
wherein said certificate revocation list includes said registration authority identifier in the event the associated registration authority has been determined to be untrustworthy and at least one value defining a time interval during which said registration authority is deemed to be untrustworthy,
said second server being operative in response to a certificate revocation inquiry request to provide a revocation indication if said certificate revocation list contains a registration authority identifier that corresponds to said registration authority identifier within said certificate and a time stamp associated with said registration authority identifier that is within said interval.

25. The system of claim 23 wherein said second server comprises a revocation server.

26. The system of claim 25 wherein said revocation server is further operative in response to said revocation indication to forward a certificate revocation message to said first server that indicates that said certificate has been revoked.

27. The system of claim 26 wherein said first server is operative in response to said certificate revocation message to deny said principal access to said requested resource.

28. A computer program product including a computer readable medium, said computer readable medium having a computer program stored thereon for generating a certificate, said computer program being executable by a processor and comprising:
program code for receiving a request from a registration authority to issue a certificate on behalf of a principal;
program code operative in response to recognition of said request, for generating by a certification authority a certificate authenticated by said certification authority wherein said certificate includes at least a principal identifier associated with said principal, a key associated with said principal for use in authenticating messages generated by said principal, and a registration identifier associated with said registration authority.

29. The computer program product of claim 28 wherein said program code for generating said certificate is further operative to include within said certificate a time stamp associated with a time or receipt by said certification authority of said request from said registration authority of said request to issue said certificate.

30. A computer data signal, said computer data signal including a computer program for use in generating a certificate, said computer program comprising:
program code for receiving a request from a registration authority to issue a certificate on behalf of a principal;
program code operative in response to recognition of said request, for generating by a certification authority a certificate authenticated by said certification authority wherein said certificate includes at least a principal identifier associated with said principal, a key associated with said principal for use in authenticating messages generated by said principal, and a registration identifier associated with said registration authority.

31. The computer data signal of claim 30 wherein said program code for generating said certificate is operative to include within said certificate a time stamp associated with a time of receipt by said certification authority from said registration authority of said request to issue said certificate.

32. The computer data signal of claim 30 wherein said computer program further includes program code for publishing said certificate.

33. The computer data signal of claim 30 wherein said program code for publishing said certificate includes program code for forwarding said certificate to a directory server.

34. An apparatus for generating a certificate in a computer network comprising:
means operative in response to receipt of a request from a first node coupled to a computer network at a second node coupled to said network for generating at said second node a certificate that includes a first node identifier associated with said first node.

35. The apparatus of claim 34 wherein said request was initiated by a principal and said request includes a principal identifier associated with said principal and said certificate further includes said principal identifier and a public key associated with said principal.

36. The apparatus of claim 34 wherein said certificate is authenticated by said second node.

37. The apparatus of claim 34 further including means for comparing said first node identifier to a node identifier associated with an untrustworthy node on said network that is contained within a certificate revocation list and providing an indication that said certificate is untrustworthy in the event said first node identifier matches said untrustworthy node identifier.
